(19) United States
(12) Patent Application Publication
(10) Pub. No.: US 2005/0179665 A1
(43) Pub. Date: Aug. 18, 2005

(54) [MULTIFUNCTIONAL NUMBERAL KEYPAD]

(75) Inventor: Wen-Hsiu Kuo, TAIPEI (TW)

Correspondence Address: WEN-HSIU KUO, P.O. BOX 108-00403, TAIPEI, TW

(73) Assignee: Wen-Hsiu Kuo, Sanchung City (TW)

(21) Appl. No.: 10/906,141

(22) Filed: Feb. 4, 2005

(30) Foreign Application Priority Data
Feb. 12, 2004 (TW) 093202010

(51) Int. Cl. G09G 5/00

(52) U.S. Cl. 345/168

(57) ABSTRACT

A multifunctional numeral keypad integrated for serving as a computer input device comprises a housing, a numeral keypad positioned a top side of the housing, a calculator portion positioned within the housing, a mouse portion positioned under the housing, and a circuit board for controlling function. The housing comprises a keypad portion disposed on a surface thereof for inputting numeral data or controlling function into a personal computer, wherein the housing is capable of generating a cursor signal for moving a cursor along X and Y axes is disposed on a bottom side by a user moving the housing, and at least one function key disposed on a surface of the housing for selecting object function. The circuit board is set in the housing and electrically connected to the keypad portion and the mouse portion and the calculator portion, wherein the circuit board comprises a processor within built-in a memory for store the control program for performing a computer of inputting numeral keypad mode, a arithmetic operation of calculator mode, and a mouse functions mode.

This application claims the priority benefit of Taiwan patent application number 093202010 filed on Feb. 12, 2004.

### DESCRIPTION

### BACKGROUND OF THE INVENTION

1. The Field of the Invention

The present invention relates to a multifunctional numeral keypad, and more particularly to a multifunctional numeral keypad is integrated for a capable of functioning as a inputting numeral data, a mouse function and a calculator function.

2. Description of Related Art

In the modern world, the personal computer has become an essential tool for human beings. Several peripheral devices, such as keyboard, mouse and other input devices are required in order to fully enjoy the personal computer. The conventional keyboard has a set of numeral keys on the right side for conveniently inputting numeral data. However, certain users, for example, accountants, generally do not like to operate the numeral keys located on the right side of the keyboard, and because of the large size of the conventional keyboard interferes with placement of reference documents in a convenient position on the desk. Furthermore, there are several peripheral devices, such as monitor, keyboard, mouse and conventional keypad essential for conveniently operating the personal computer, and calculators, accounting documents and office stationeries, all these things cannot be properly placed on the desk and could possibly mess the desk. In order to overcome the aforementioned inconvenience, some manufacturers designed comparatively smaller external numeral keypad. Even though such smaller external numeral keypad provide greater convenience, however, when the user need to input numeral data on certain specific location in the screen, the user has to use the mouse to move the cursor to that specific location in the screen and then use the numeral keypad to input the numeral data. Thus, the user often needs to switch between the mouse and the numeral keypad several times. Such operations take significant amount of precious time, and thus reduce the efficiency. Besides, the external numeral keypad requires an extra cord for connecting with the computer, which may interfere with other wires, or peripheral devices or other things placed on the desk and may cause a mess.

Furthermore, the popular online games require the mouse and the keyboard to input certain codes and commands to enjoy the online game. Because, most of the online games are real-time battle games, therefore switching between the mouse and the keyboard causes inconvenience to the player but also cause anxiety.

Therefore, to overcome the above defects is an important issue to the manufacturer in the field.

### SUMMARY OF THE INVENTION

Accordingly, in the view of the foregoing, the present inventor makes a detailed study of related art to evaluate and consider, and uses years of accumulated experience in this field, and through several experiments to create a novel multifunctional numeral keypad.

According to an aspect of the present invention, the multifunctional numeral keypad is designed into a structure of a mouse and is integrated a capable of functioning as a mouse mode, a inputting numeral keypad mode and a calculator mode so that the space occupation on the desk can be significantly reduced. Furthermore, the multifunctional numeral keypad of the present invention comprises a light emitting effect.

According to an embodiment of the present invention, the multifunctional numeral keypad comprises a housing having a keypad portion disposed on a surface thereof and a mouse portion assembled including a X-Y axis of cursor device disposed on bottom and a calculator portion including a LCD display disposed on topside thereof. The multifunctional numeral keypad is electrically connected to a circuit board for controlling operation. Key signals and cursor signals are generated and transmitted to the computer by operating the keys and the mouse respectively, and the operating calculator function displaying on the LCD display.

According to a preferred embodiment of the present invention, the multifunctional numeral keypad comprises a keypad portion including a plurality of keys and a conducting protrusion is positioned under each key thereof. The circuit board comprises a keypad controlling circuit and layout a plurality of conducting circuits forming a plurality of electrical contact points are correspondingly positioned below the conducting protrusion By pressing the electrical contact points, key signals are generated.

According to an embodiment of the present invention, the keypad portion of the multifunctional numeral keypad comprises a plurality of light emitting diode (LED) or the electroluminescent panel to shine light for operating the multifunctional device in the night. And having a LED indicator is disposed on a top case of housing for indicating status of operation mode.

According to an embodiment of the present invention, the mouse portion of the multifunctional numeral keypad comprises a device for directing a location along the X-Y axis is disposed on a bottom side said housing, and a mouse controlling circuit for generating the cursor signal to said computer when a user moving said housing, and further including at least one function key disposed on a surface of said housing for selecting object function.

According to an embodiment of the present invention, the multifunctional numeral keypad comprises a calculator device disposed on inside said keypad housing, wherein said calculator including a LCD display disposed on a surface for displaying key-in a numerical data and calculation results on the LCD display thereof and a calculation circuit for processing calculation function, and wherein said calculator functions including plurality of function keys disposed on a surface of said housing, in which at least having such as addition, subtraction, multiplication and division of basic arithmetic operation.

### BRIEF DESCRIPTION OF THE DRAWING

For a more complete understanding of the present invention, reference will now be made to the following detailed description of preferred embodiments taken in conjunction with the following accompanying drawings.

FIG. 1 is a top view of a multifunctional numeral keypad according to an embodiment of the present invention.

FIG. 2 is an exploded view of a multifunctional numeral keypad according to an embodiment of the present invention.

FIG. 3 is an exploded view of a keypad portion of a multifunctional numeral keypad according to an embodiment of the present invention.

FIG. 4 is a cross sectional side view of the keypad portion of a multifunctional numeral keypad according to an embodiment of the present invention.

FIG. 5 is an exploded view of a multifunctional numeral keypad with the electroluminescent panel according to an embodiment of the present invention.

FIG. 6 is a block diagram of a circuit of a multifunctional numeral keypad according to an embodiment of the present invention.

### DETAILED DESCRIPTION OF EMBODIMENTS

Reference will be made in detail to the preferred embodiments of the invention, examples of which are illustrated in the accompanying drawings. Wherever possible, the same reference numbers are used in the drawings and the description to refer to the same or like parts.

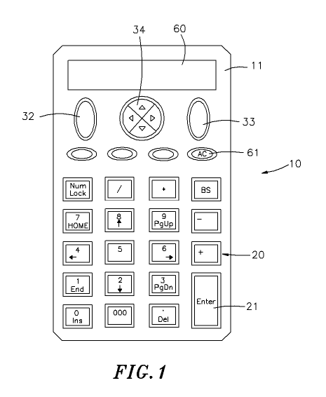

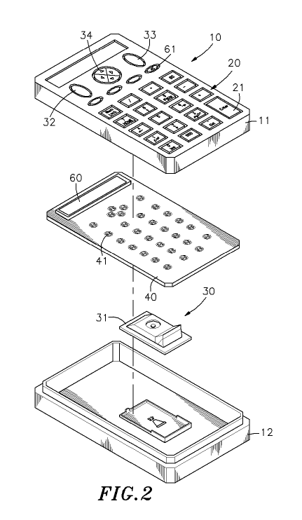

FIGS. 1 and 2 show a top view and an exploded view of a multifunctional numeral keypad according to an embodiment of the present invention. The housing 10 is assembled with an upper case 11 and a lower case 12. The housing 10 comprises a numeral keypad portion 20 assembled on a surface thereof, a mouse portion 30 assembled thereof, a calculator portion 60 assembled thereof, and at least a circuit board 40 assembled. The circuit board 40 is electrically connected to the keypad portion 20 and the mouse portion 30 and the calculator portion 60. In the inputting numeral data mode, so that a user may press a key in the keypad portion 20 to generate and transmit a numerical data signal or function signal to a computer. In the mouse mode, moving housing 10 and operating the mouse portion 30 to generate a cursor signal and mouse function to a computer. In the calculator mode, key-in a numerical data and arithmetic function displaying on the LCD display of the calculator 60.

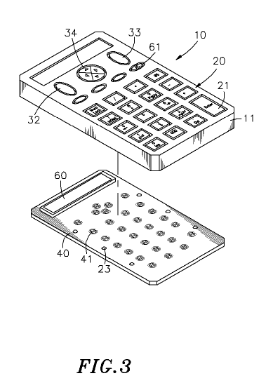

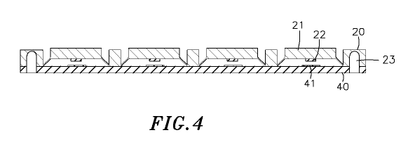

FIGS. 3 and 4 show an exploded and a cross sectional side view of the keypad portion of the multifunctional numeral keypad according to an embodiment of the present invention, respectively. The keypad portion 20 comprises a plurality of keys 21 positioned on the surface of the housing 10, wherein the keys 21 assembled may be made of membrane, rubber or elastic material. Each of the keys 21 comprises a conducting protrusion 22 formed at a bottom under each key 21 thereof, and the circuit board 40 comprises a keypad control circuit. The control circuit board 40 layout a plurality of conducting circuits forming a plurality of the electrical contact points 41 positioned below the corresponding plurality of the conducting protrusions 22. When the user presses the keys 21, the keys 21 under conducting protrusion 22 are electrically touched with the electrical point 41 to generate and transmit the function-key signal to the computer.

Furthermore, the keypad 20 disposed on a rearward of top side of housing, the plurality of keys 21 comprises a numeral keys for “0” to “9”, and arithmetic function keys for “+”, “−”, “*”, “/”, and decimal point key for “.”, and an “Enter” key and a “Num lock” key and so on, in which numeral keypad may be changed to other computer functions mode associated with a “Num Lock” key, wherein the computer functions mode comprises a four direction pointer key for “↑”, “↓”, “←”, “→”, and browse page keys for “page-up”, “page-down”and an “Ins”key and a “Del”key and a “Home” key and a “End” key and so on (as shown in FIG. 1).

FIG. 4 shows a cross sectional side view of a keypad portion of the multifunctional numeral keypad according to an embodiment of the present invention. The plurality of keys 21 and the housing 10 may be made of a transparent or semi-transparent material. One or one more of the light emitting diodes (LED) 23 may be disposed on the two sides of the circuit board 40 and electrically connected to the circuit board 40, wherein the light-emitting diode 23 emit light comprising at least one color for operating the multifunctional device in the night by the circuit board 40 controlling action.

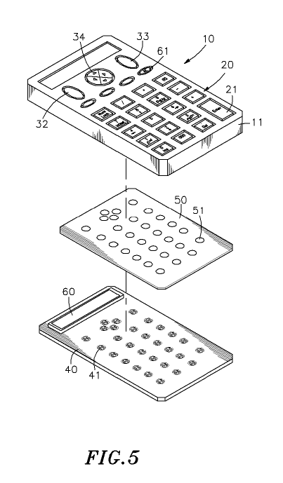

FIG. 5 shows an exploded view of the multifunctional numeral keypad with the electroluminescent panel according to an embodiment of the present invention. As shown in FIG. 5, an electroluminescent panel 50 is electrically connected to the circuit board 40, wherein the electroluminescent panel 50 is capable of emitting light for operating the multifunctional device in the night by the circuit board 40 controlling action. The electroluminescent panel 50 comprises apertures 51 corresponding to the keys 21, and the conducting protrusions 22 of the keys 21 are electrically connected to the electrical contact points 41.

Referring back to FIG. 2, the mouse portion 30 comprises a device 31 for directing the location on the X-Y axis and a mouse control circuit board 40. The device 31 may be an optical mouse device including a lens 31 disposed on the bottom case for reflection a light of change on the desk surface to optical sensor (no show) in the circuit board 40 when a user moving housing and the LED (no show) light in the circuit board 40 is turned on, wherein the optical sensor generate a X-Y axis signal to microcontroller processing and output a cursor signal displaying on the screen of a computer. In additional, the device 31 is a trace ball device (no show), the track ball disposed on the bottom case and associated with the X-Y axis of IR-PTR (no show) in the circuit board 40 to generate a cursor signal to a computer. Wherein the mouse control circuits are layout in the circuit board 40 and are electrically connected to the device 31. Thus, a user may move the housing 10 to command the device 31 to generate and transmit the cursor signal along the X-Y axis of to a computer. Now referring to FIG. 1, the housing 10 comprises the plurality of keys with mouse functions, such as a left function key 32, a right function key 33, and a middle function disposed on a surface of housing for selecting a ICON and computer function, and a browse page device 34 for rolling page function disposed on a surface of the housing, wherein the browse page device may be a multi-directional joystick device or a wheel roller device 34 for functioning as a page-up, a page-down, or a page-left and a page-right. These functional keys are electrically connected to the mouse control circuit allowing the user to use the mouse to select the functions and roll the page on the screen.

FIGS. 1, 2 and 6 show a top view, an exploded view and a block diagram of a circuit of the multifunctional numeral keypad according to an embodiment of the embodiment of the present invention. The housing 10 having a calculator portion comprises a LCD display 60 on a surface thereof, and the circuit board 40 comprises a calculation circuit and function keys 61. The calculation circuit, the keys portion 20, the arithmetic operation function keys 61 and the LCD display 60 are electrically connected to the control circuit board 40. When a user input a numeral key of the keypad portion 20 and performing a arithmetic operation, for example but not limited to, such as addition, subtraction, multiplication and division, and obtain the calculation result displaying on the display 60. The housing 10 also comprises a plurality of switches 61 including other functions of calculator and are electrically connected to the circuit board 40, wherein the switches 61 is adopted including a switching operation modes, such as a inputting numeral data and function to a computer, a calculator function or a mouse function effect.

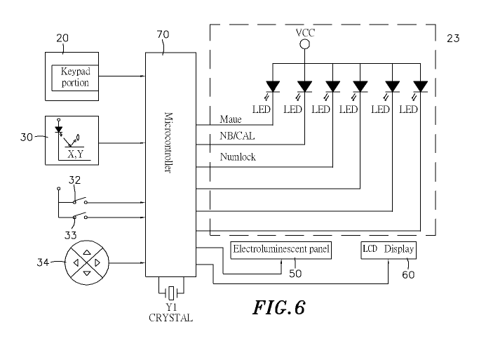

Referring to FIG. 6, the circuit of the multifunctional numeral keypad comprises at least one microcontroller 70 within built-in a memory for store the control program. The microcontroller are connected to the keypad control circuit, the mouse control circuit and the calculator circuit, wherein the microcontroller 70 is adopted for receiving and processing the inputting numeral keys signal of the keypad portion 20 to a computer, and processing and output a cursor signal of the mouse portion 30 to a computer on the screen, and processing the functional keys 32 of the mouse portion 30 including at least a right function key and left function key for selecting a ICON, and processing the browse page function 33 of the mouse portion 30 for browse a page-up, page-down or a page-right, page-left, wherein the browse page device 33 may be a wheel roller or joystick. The microcontroller 70 process the key in a numeral data and arithmetic operation function of the calculator to displaying on the LCD display 60, and controls the light-emitting diode 23 or the electroluminescent panel 50 for operating the multifunctional numeral keypad at night, and having at least one LED indicator for indicating status of operation mode.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A multifunctional numeral keypad, integrated for serving as a computer input device for inputting numerical data and mouse function, and independently operative calculator function, comprising:
a housing;
a numeric keypad portion including a plurality of keys disposed on a top side of said housing thereof, for inputting numerical data or controlling function to said computer;
a mouse portion, disposed within said housing, wherein said mouse including a X-Y axis device deposed on a bottom side said housing for generating a cursor signal to said computer when the user moving said housing, and including at least one function key disposed on a surface of said housing for selecting object function; and
a calculator portion disposed within said housing, wherein said calculator including a LCD display on a surface of said housing for displaying key-in a numerical data and calculation result, and including plurality of function keys disposed on a surface of said housing and operative for arithmetic function of said calculator;
a circuit board, set within said housing, and electrically connected to said keypad portion and said mouse portion and calculator portion, wherein said circuit board comprises at least one microcontroller, and said control program stored in a memory said microcontroller for controlling and processing said functions of said device.

2. The multifunctional numeral keypad according to claim 1, wherein said keypad portion comprises a plurality of keys, and a conducting protrusion is positioned under each key, and said circuit board comprises a keypad control circuit layout a plurality of electrical contact points assembled by a plurality of conducting circuits and are correspondingly positioned below said conducting protrusion.

3. The multifunctional numeral keypad according to claim 2, wherein said keys are comprised of membrane.

4. The multifunctional numeral keypad according to claim 2, wherein said keys are comprised of rubber.

5. The multifunctional numeral keypad according to claim 2, wherein said keys are comprised of an elastic material.

6. The multifunctional numeral keypad according to claim 1, wherein said a X-Y axis device of mouse is an optical device.

7. The multifunctional numeral keypad according to claim 1, wherein said a X-Y axis device of mouse is a trace ball.

8. The multifunctional numeral keypad according to claim 1, wherein said mouse portion comprises a plurality of functions device disposed on a surface of housing for selecting a icon and browse page of computer functions displaying on the screen.

9. The multifunctional numeral keypad according to claim 8, wherein said mouse of function keys comprises at least a left key, a right key.

10. The multifunctional numeral keypad according to claim 8, wherein said browse page of function device for page-up, page-down.

11. The multifunctional numeral keypad according to claim 8, wherein said browse page of function device for page-up, page-down, page-right, page-left.

12. The multifunctional numeral keypad according to claim 1, wherein said keypad disposed on a rearward of top side of housing, said a plurality of keys comprises a numeral keys “0” to “9”, and arithmetic function keys “+”, “−”, “*”, “/”, and decimal point key “.”, and an “enter” key and a “Num lock” key.

13. The multifunctional numeral keypad according to claim 12, wherein said keypad be changed to other operating mode for a “pointer” key and a “page-up” key and a “page-down” key and an “Ins” key and a “Del” key and a “Home” key and a “End” key, so said functions need associated with a “Num Lock” key.

14. The multifunctional numeral keypad according to claim 12, wherein said keypad in the calculator mode for inputting a numerical data and performing at least an addition, subtraction, multiplication and division of arithmetic operation functions.

15. The multifunctional numeral keypad according to claim 1, wherein said a plurality of function keys disposed on a surface of housing comprising a switch for selecting a computer keypad mode for inputting numeral data, or a calculator operation mode, or a mouse operation mode.

16. The multifunctional numeral keypad according to claim 1, wherein said at least one LED disposed on a top side of housing, in which said LED indicator for indicating status of operation mode.
